(19) United States
(12) Patent Application Publication
(10) Pub. No.: US 2008/0160482 A1
(43) Pub. Date: Jul. 3, 2008

(54) Pre-filled Prophylaxis Cup with an Internal Secondary Reservoir

(75) Inventor: Steven D. Jensen, South Jordan, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO GROUP, INC., West Jordan, UT (US)

(21) Appl. No.: 11/618,521

(22) Filed: Dec. 29, 2006

(51) Int. Cl. A61C 17/00; A61C 3/06

(52) U.S. Cl. 433/165; 433/166

(57) ABSTRACT

The present invention is a prophylaxis cup having a secondary reservoir pre-filled with prophylaxis paste for a dental procedure. The secondary reservoir is separated from the cleaning portion of the cup by a dividing ring with a central orifice, the size of which will determine the flow of paste. In use, the clinician merely presses the cup against the target surface to express paste into the cleaning portion. Additional structure may be employed to further retard seepage of paste out of the cup. Being an elastomeric material, the cup may be impregnated with active ingredients to provide a substitute for additional paste.

### FIELD OF THE INVENTION

The present invention relates to the field of dentistry and tools used in dentistry and more particularly relates to a pre-filled prophylaxis cup having a secondary reservoir of prophylaxis paste and to be used in dental procedures.

### BACKGROUND OF THE INVENTION

One of the most common tools used in the field of dentistry is the prophylaxis cup, or “prophy cup” as it is usually termed. The prophy cup is the attachment secured to a dental low speed handpiece that is used in the actual cleaning and polishing of teeth. The prophy cup is attached to the handpiece's head and is then rotated at speeds approaching 5000 RPM. The prophy cup is then placed in contact with tooth surfaces to clean and polish the patient's teeth. The rotation of the prophy cup combined with prophylaxis paste (“prophy paste”) actually allows for debridment of tartar and other hard build-up on the teeth. Usually a prophy paste is applied to the teeth by dipping the prophy cup into the paste and using the prophy cup to carry the paste to the mouth. The paste provides both lubrication for the prophy cup and, usually, contains a scouring agent to aid in debridment. Different grades of paste are manufactured and used to achieve the polishing result for different situations (e.g. heavy tartar build-up, heavy staining, etc.)

The usual cleaning procedure is that a dentist or other clinician will regularly pause the cleaning procedure to fill the prophy cup with paste, constantly returning to a pre-filled well of paste. Centrifugal force caused by the rotation of the prophy cup then forces the paste out of the prophy cup and onto the target tooth surfaces. Unfortunately, this force tends to cause a rapid loss of paste, associated waste, and frequent refillings. Prophy cups have been designed to slow this process down by adding fins, channels and other structures to both retain more prophy paste for a longer period of time and increase cleaning effectiveness. All of these do help in retaining paste. One particular prophy cup actually has structure forming a quasi-reservoir. This quasi-reservoir is filled with paste, but its primary purpose is to, again, slow the inexorable flow of paste out of the prophy cup. All of these structures will still require refilling, though at a reduced frequency compared to a smooth prophy cup. What is ideally needed is a prophy cup that not only slows the loss of prophy paste, but also one that could contain all of the prophy paste necessary for a procedure. While the structures in the prior art are somewhat effective in slowing the flow of paste out of the prophy cup, nothing in the prior art teaches a true secondary containment reservoir, much less a pre-filled prophy cup that would contain all of the necessary prophy paste for an average procedure.

The present invention is a pre-filled prophy cup, containing all of the prophy paste necessary for a discrete portion of a cleaning procedure (i.e., cleaning a child's teeth or ½ of an adult's). The prophy cup according to the present invention may utilize all of the techniques and structures of the prior art to even further its effectivness. The present invention represents a departure from the prior art in that the prophy cup of the present invention comprises a contained and sealed cup with two prophy paste reservoirs. Ideally, the prophy cup is pre-filled with a given paste of specified abrasion qualities. The clinician then merely opens the prophy cup and places it on the handpiece for a given procedure with no refillings necessary. In the event the prophy cup reservoirs are exhausted, the clinician merely replaces it, popping the old one off and securing a new one. An orifice between the reservoirs allows prophy paste to be dispensed and the elastomeric properties of the prophy cup actually allow the clinician to control dispersion.

### SUMMARY OF THE INVENTION

In view of the foregoing disadvantages inherent in the known types of prophy cups, this invention provides an improved prophy cup with a secondary containment reservoir. As such, the present invention's general purpose is to provide a new and improved prophy cup that is easy and effective in use and reduces or eliminates the need to refill a prophy cup with paste during a cleaning procedure.

To accomplish these objectives, the prophy cup comprises a metal shank, ideally steel, upon which the prophy cup is mounted. The cup body is a generally cylindrical elastomeric form that flares at its open end. The cup is divided into two sections, the internal secondary reservoir and the external cleaning cup, which functions as an initial outer reservoir. An orifice allows fluid communication between the two portions. The actual structure of the cleaning cup is limited only by imagination as any of the cleaning and retention structures used in the prior art or that could be developed could be incorporated for increased effectiveness. The reservoir orifice serves as the gateway of flow, and its size will greatly determine that flow. The elastomeric qualities of the cup itself will also affect flow. A clinician may press the prophy cup against the target surface to force more paste out of the secondary reservoir. The harder the prophy cup, the more force is necessary to dispense prophy paste contained in the secondary reservoir, resulting in a generally slower flow of paste. The prophy cup itself may be made of a material impregnated with surfactants, flavors, and other compounds to add utility and further reduce the need to refill. The technology to do so is disclosed in U.S. application Ser. No. 11/381,320 filed May 5, 2006 and published Dec. 7, 2006 as US-2006-0275369-A1, also invented by Applicant. This application is hereby incorporated by reference.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view, in partial section, of the prophy cup according to the present invention.

FIG. 2 is the prophy cup of FIG. 1, the secondary reservoir and cup being filled with prophy paste.

FIG. 3 is the prophy cup of FIG. 2, mounted upon a handpiece, and rotating.

FIG. 4 is a perspective view of a prophy cup, without a secondary reservoir, impregnated with ingredients.

### DETAILED DESCRIPTION OF THE PREFERRED EMBODIMENT

With reference now to the drawings, the preferred embodiment of the improved prophy cup is herein described. It should be noted that the articles “a”, “an” and “the”, as used in this specification, include plural referents unless the content clearly dictates otherwise.

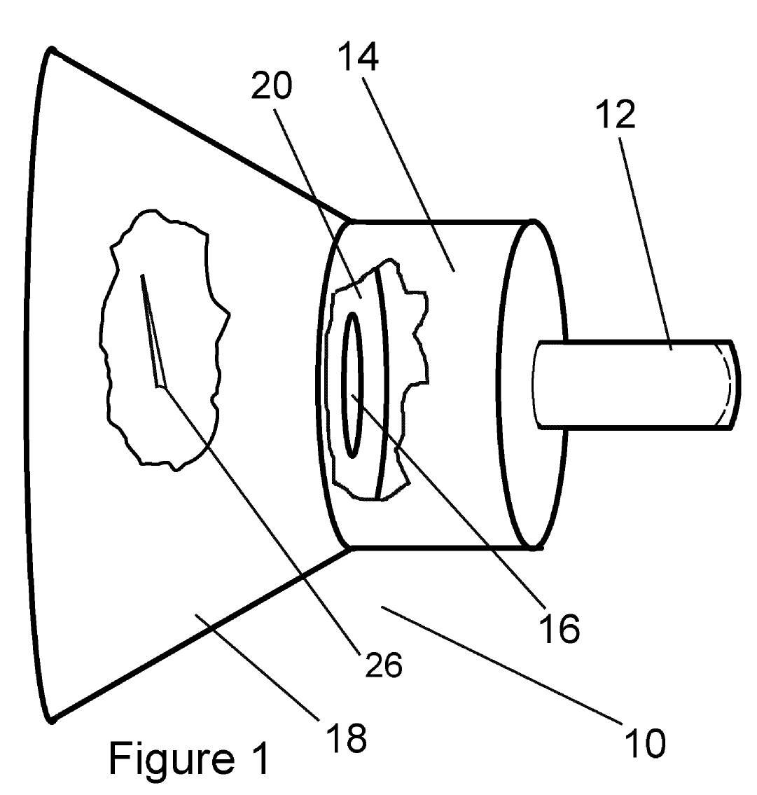

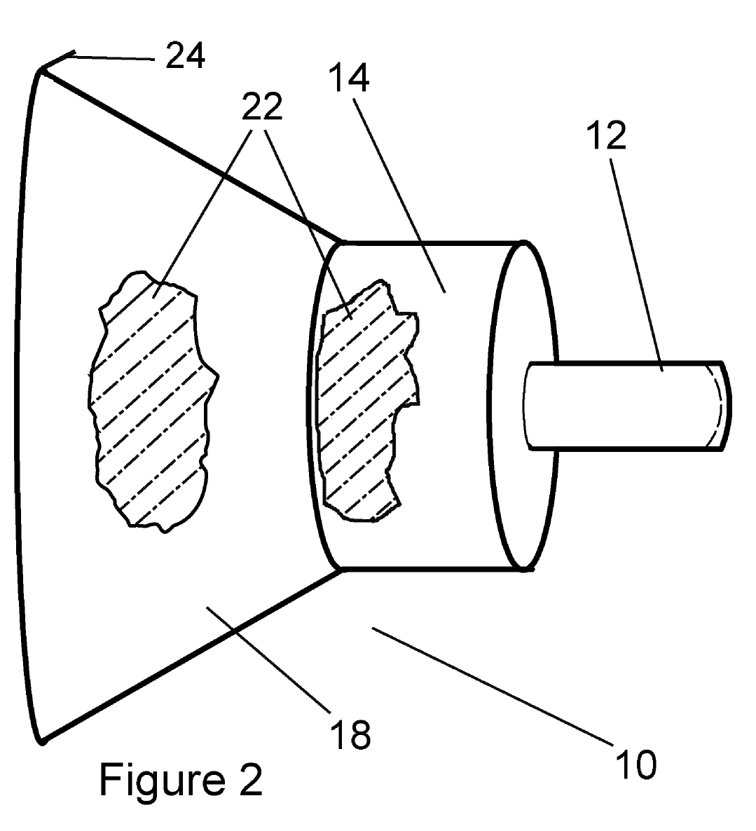

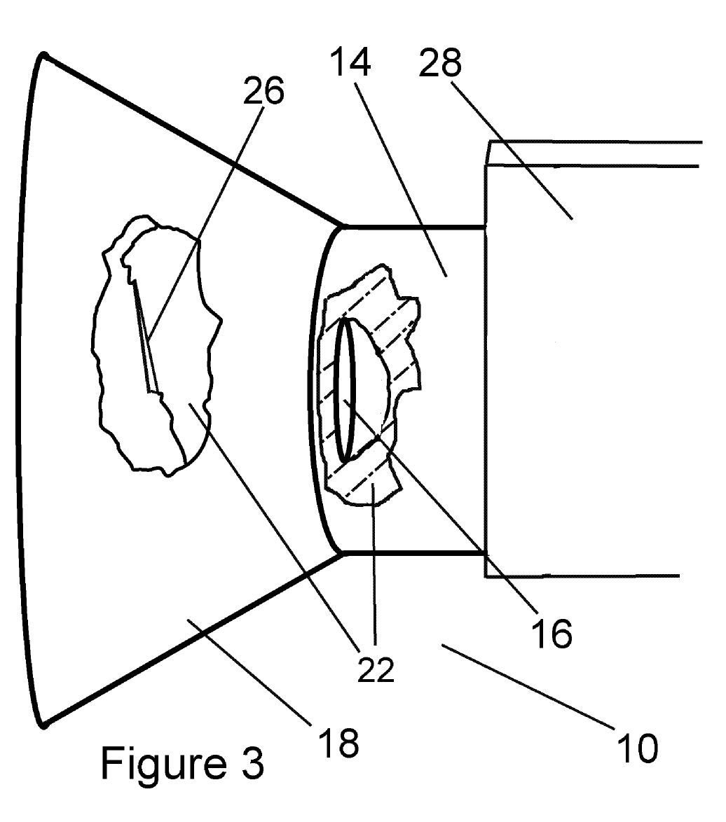

With reference to FIG. 1, the prophy cup comprises a steel shank 12 defining a central axis and providing both attachment means to the dental handpiece 28 (FIG. 3) and mounting structure for the cup body 10. Cup body 10 is further comprised of two parts, the internal, secondary reservoir 14 and the cleaning cup 18. Orifice 16 provides communication between the secondary reservoir 14 and the cleaning cup 18. Cleaning cup 18 is generally conical, but may also be hemispherical or any shape between the two extremes. The only requirement is that it present some form of a flared surface to receive both prophy paste 22 from the secondary reservoir 14 and targeted teeth. The cleaning cup 18 and secondary reservoir 14 may then be filled with prophy paste 22, and the cleaning cup sealed with a cover 24 to maintain storage and freshness of the prophy paste 22, shown in FIG. 2. Cover 24 may be any type of cover known in the art, including peel-off covers like the one shown, though such covers made of foil may not be advisable as a small, retained piece of foil could prove hazardous on a dental surface at the handpiece's generated RPM's. Ideally, the cover's structural integrity should be stronger than the seal by multiple times.

As the prophy cup spins, shown in FIG. 3, prophy paste 22 is normally directed outwards due to the centrifugal forces involved. This seepage is generally directed along the side walls of the prophy cup. The present invention presents a dividing ring 20, which acts as a dam, and an axially located orifice 16 between the secondary reservoir 14 and cleaning cup 18. Due to the axial location of the orifice 16, dividing ring 20 is of uniform height. The use of the dam-like dividing ring 20 and orifice 16 reduce paste loss by retaining prophy paste 22 until expressed outwards by the clinician.

The clinician accomplishes the act of expression by pressing the cup body 10 against the targeted cleaning surface, compressing the secondary reservoir 14 and forcing paste 22 through the orifice 16 into the cleaning cup 18. The orifice 16 and the dividing ring 20 comprise a cross-sectional area equal to a cross-sectional area of the cup at the plane in which the dividing ring 20 and orifice 16 are located. The size of the orifice 16 (and the corresponding width of the dividing ring 20) will regulate the flow of prophy paste 22 out of the secondary reservoir 14. Ideally, the orifice 16 should have a cross-sectional area of between 0.1 to 30% of the total cross-sectional area of the prophy cup at its location, though any percentage will have some efficacy. The smaller the orifice 16, the less prophy paste 22 will be allowed to escape. Orifice 16 may be of any shape or location (thus affecting the shape of the dividing ring), but the uniformity of a circular, axially located orifice 16 aids in uniform expression of the prophy paste 22 by clinician. Therefore, the terms “orifice” and “ring” should be so construed to include other shapes that would accomplish their functions, though technically not a true “ring” or “circle.”

While not critical to the invention, the use of other structures known in the prior art to further reduce the seepage of prophy paste 22 can be beneficial. Such seepage retardation means and structures, like fin 26, place further obstacles in the path of the paste 22 as it seeps outward. Such structures include grooves, fins, channels, abutments, and a threaded structure inside of the cleaning cup 18.

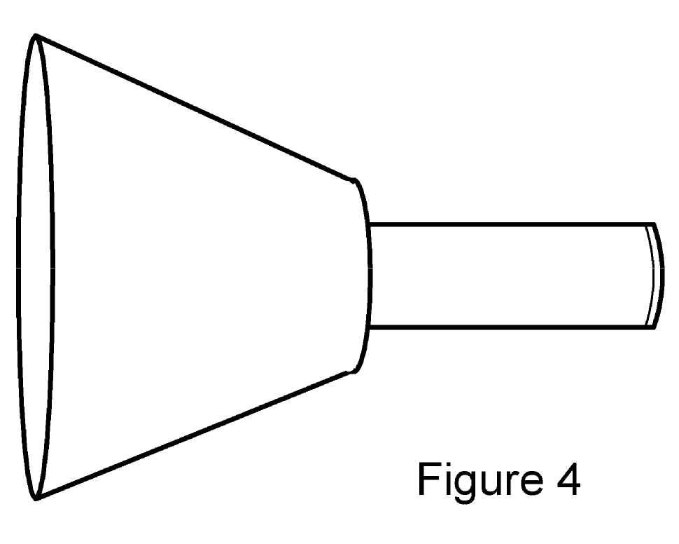

The materials the prophy cup according to the present invention may be the standard materials for the art, a generally elastomeric, rubberized plastic and a steel post. The elastomeric material may be any known in the art and its elastomeric qualities will vary according to the purpose of the cup (i.e. heavy or light duties). The hardness of the material should range between 20A and 70A durometers. The cup body 10 itself may be impregnated with cleansing aids such as solvents, surfactants, abrasives, and emulsifiers, so that the cup body 10 releases a kind of prophy paste itself. In effect, a prophy cup may be made of such impregnated materials alone, without a secondary reservoir, shown in FIG. 4. As the goal of the invention is to reduce or eliminate the need of a clinician to refill a prophy cup in a procedure, so the secondary reservoir 14 should have a capacity of holding up to 1 cc of prophy paste and may hold less, to a minimum of 0.1 cc if the prophy cup itself contains active cleaning ingredients.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A prophylaxis cup comprising:
a. An attachment post;
b. A generally cylindrical cup body made from an elastomeric material, said cup body further comprising:
i. a closed hind end, proximate the attachment post;
ii. a flared open end, opposite the attachment post; and
iii. an internal division ring, dividing an interior of the cup body into two sections, a first, cleaning section and a second, reservoir section proximate the closed end, and allowing fluid communication between said sections through an orifice defined by the division ring.

2. The prophylaxis cup of claim 1, further comprising prophylaxis paste pre-filled in at least the secondary reservoir section.

3. The prophylaxis cup of claim 1, the orifice having between 0.1 and 30% of a cross-sectional area of the cup body taken at plane in which the orifice is located.

4. The prophylaxis cup of claim 1, the secondary reservoir having an internal volume of between 0.1 and 1 cc.

5. The prophylaxis cup of claim 1, the elastomeric material having a hardness measuring in a range between 20A and 70A durometers.

6. The prophylaxis cup of claim 1, the cup body made from an elastomeric material that has been impregnated with at least one additional ingredient selected from the group of ingredients consisting of: abrasives, surfactants, emulsifiers, flavors and sweeteners.

7. The prophylaxis cup of claim 1, further comprising seepage retardation means inside the cleaning cup.

8. A prophylaxis cup made from an elastomeric material, said material impregnated with at least one ingredient selected from the list of ingredients consisting of: flavors, surfactants, and sweeteners.

9. The prophylaxis cup of claim 8 the material also being impregnated with an abrasive.
